(19) United States
(12) Patent Application Publication
(10) Pub. No.: US 2022/0305494 A1
(43) Pub. Date: Sep. 29, 2022

(54) SAMPLE ADDING NEEDLE FOR PREPARING MICRODROPLETS AND MICRODROPLET PREPARATION METHOD

(71) Applicant: BEIJING DAWEI BIOTECH LTD., Beijing (CN)

(72) Inventors: Rongrong WENG, Beijing (CN); Dongyang CAI, Beijing (CN)

(73) Assignee: BEIJING DAWEI BIOTECH LTD., Beijing (CN)

(21) Appl. No.: 17/639,010

(22) PCT Filed: Aug. 28, 2020
(86) PCT No.: PCT/CN2020/112172

§ 371 Date: Feb. 28, 2022

(30) Foreign Application Priority Data
Aug. 30, 2019 (CN) 201910816533.X

(51) Int. Cl. B01L 3/00

(52) U.S. Cl. CPC B01L 3/502784; B01L 2200/027; B01L 2200/0673; B01L 2300/0838; B01L 2400/0406

(57) ABSTRACT

Disclosed in the present application is a sample adding needle for preparing microdroplets, comprising a liquid storage portion and a liquid discharge portion, which are integrally injection molded and penetrate one another; the liquid storage portion is a truncated cone the radial dimension of which gradually decreases in the direction facing the liquid discharge portion, and the liquid discharge portion is a truncated cone the radial dimension of which gradually decreases in the direction away from the liquid storage portion; the taper of the liquid storage portion is C1, the taper of the liquid discharge portion is C2, and C1≤C2; the wall thickness of the liquid storage portion is D1, the wall thickness of the liquid discharge portion is D2, and D1>D2. For the sample adding needle for preparing microdroplets as described in the present application, when preparing microdroplets by using the sample adding needle, the sample adding needle performs periodic reciprocating motion at varying speeds in an oily liquid such that a sample solution is subject to periodic shear force from the oily liquid at a liquid discharge opening, thereby enabling the sample solution within the sample adding needle to enter the oily liquid, thus achieving the production of microdroplets having uniform size and controllable volume.

### FIELD OF THE INVENTION

The present application relates to the fields of microfluidics, microscale material preparation, microreactors, and microanalysis technology, and specifically to a sample adding needle for preparing microdroplets and a method for preparing microdroplets.

### BACKGROUND OF THE INVENTION

Microdroplets are widely used in various fields, and microdroplets based microfluidic technologies have been rapidly developed and applied in single-cell analysis, single-cell sequencing, digital PCR, protein crystallization, high-throughput reaction screening, and single-cell functional sorting.

Microdroplet production uses two mutually immiscible phases to generate emulsified microdroplets. The microdroplet phase is referred to as dispersed phase and the phase encasing the microdroplet is referred to as continuous phase. After the production of microdroplets, they can be split, fused, mixed, diluted, collected and sorted, etc. Therefore, it is important to control the shape, size and monodispersity of microdroplets.

In the prior art, microdroplet production techniques are mainly as follows. One is using microfluidic chips to produce microdroplet, which is based on interfacial instability when the dispersed and continuous phases intersect in a microchannel. Depending on its driving force (e.g., gravity, centrifugal force, propulsion), the complexity of the device and the tediousness of its operation vary, so it requires skilled operators to make and operate it. The second one is to generate microdroplets by using special devices for spraying trace amount of liquid, such as special spraying or microdroplet excitation methods using piezoelectric ceramics, thermally excited expansion, and high-voltage electrospray, etc. However this approach is relatively difficult for precise regulation of microdroplet volume and biological samples may be damaged to some extent.

### SUMMARY OF THE INVENTION

A main object of the present application is to overcome at least one of the above-mentioned defects of the prior art and to provide a sample adding needle for preparing microdroplets with uniform size and controllable volume.

A main object of the present application is to overcome at least one of the above-mentioned defects of the prior art by and to provide a sample adding needle for preparing microdroplets that is easily replaced and used in bulk.

Another main object of the present application is to provide a method for preparing microdroplets using the sample adding needle. The applicant of the present application has continued to develop the present application based on Chinese Patent No. 201410655191.5, titled Method of producing droplets with microtubules, Chinese Patent No. 201410655309.4, titled Method and system for quantitative analysis of digital nucleic acid amplification based on microdroplets, and Application No. 201821013244.3, titled A suction tip device for microdroplet production. Microdroplets produced using the method and device disclosed in the above patents have controllable size and better homogeneity. Using a capillary tube and a suction tip device with a metal capillary tube, a liquid storage chamber is integrated to the upper end of the capillary tube for easy replacement, and the capillary tube can be directly used to draw the sample and generate microdroplets by reciprocating vibration under the oil phase level. However, the following problems exist in this sample adding needle: in order to generate microdroplets with nanoliter volumes, the inner diameter of the metal capillary tube is as small as 100 microns, which makes the processing and assembly more difficult and thus the cost of the needle is too high; when drawing the sample liquid, due to the high resistance of the capillary tube, it is easy to generate vacuum and air bubbles, which limits the speed of liquid drawing and affects the uniformity of produced droplets; the hydrophobicity of the metal capillary tube itself is not enough, thus when producing droplets, the surface of the metal capillary is easy to adsorb the biomolecules in the sample liquid and become hydrophilic, resulting in discontinuity of droplets production; and the processing cost of the non-metal capillary is high and the rigidity is weak, which cannot guarantee the uniformity of produced droplets. Therefore, based on the defects of the above-mentioned methods and device, the applicant further studied the present application. This application provides a new sample adding needle for preparing microdroplets without external capillary liquid discharge opening that can be produced by integral injection molding, using the liquid discharge portion of the sample adding needle to process a liquid discharge opening with a cone-shaped opening, which solves the difficulties of straight pipeline processing and can be processed in large quantities at low cost; this design ensures the rigidity of the liquid discharge portion and the accuracy of vibration control when vibrating, and achieves homogeneous nanoliter droplets preparation with a low cost.

In order to achieve the above objects, the present application adopts the following technical solutions:

1. A sample adding needle for preparing microdroplets, comprising a liquid storage portion and a liquid discharge portion, which are integrally molded and penetrate one another, the liquid storage portion is a hollow truncated cone the radial dimension of which gradually decreases in the direction facing the liquid discharge portion, the liquid discharge portion is a hollow truncated cone the radial dimension of which gradually decreases in the direction away from the liquid storage portion, the taper of the liquid storage portion is C1, the taper of the liquid discharge portion is C2, and C1≤C2, the wall thickness of the liquid storage portion is D1, the wall thickness of the liquid discharge portion is D2, and D1>D2.

2. The sample adding needle for preparing microdroplets according to item 1, wherein the liquid storage portion has a height of 3 to 50 mm, preferably 5 to 30 mm, a taper of 2 to 30°, preferably 2 to 20°, and a wall thickness of 0.3 to 2.0 mm, preferably 0.4 to 0.5 mm.

3. The sample adding needle for preparing microdroplets according to item 1, wherein the liquid discharge portion has a height of 1 to 10 mm, preferably 2 to 5 mm, a taper of 10 to 60°, preferably 10 to 20°, and a wall thickness of 0.05 to 0.3 mm, preferably 0.1 to 0.2 mm.

4. The sample adding needle for preparing microdroplets according to item 1, wherein the liquid storage portion is provided with an adaptation portion at the end away from the liquid discharge portion, the adaptation portion is a truncated cone the radial dimension of which gradually decreases in the direction facing the liquid discharge portion, and the adaptation portion and the liquid storage portion are integrally molded.

5. The sample adding needle for preparing microdroplets according to item 4, wherein the adaptation portion is provided with a step portion surrounding the adaptation portion at the end away from the liquid discharge portion, the step portion is provided with at least one reinforcing rib at the end facing the liquid discharge portion, and the step portion is integrally molded on the adaptation portion.

6. The sample adding needle for preparing microdroplets according to item 4, wherein the adaptation portion has a height of 3 to 8 mm, preferably 3 to 5 mm, and a taper of 2 to 6°, preferably 3 to 4.5°.

7. The sample adding needle for preparing microdroplets according to item 4, wherein the adaptation portion has an liquid supply opening at the end away from the liquid discharge portion, and the liquid discharge portion has an liquid discharge opening at the end away from the liquid storage portion. 8. The sample adding needle for preparing microdroplets according to item 7, wherein the liquid discharge opening has an inner diameter of 25 to 200 μm, preferably 50 to 200 μm, more preferably 100 to 180 μm; the liquid discharge opening has an outer diameter of 200 to 800 μm, preferably 250 to 550 μm, more preferably 350 to 450 μm.

9. The sample adding needle for preparing microdroplets according to any one of items 1 to 8, wherein the sample adding needle is made of a material having a contact angle of not less than 80 degrees with the pure aqueous solution, the material is one selected from the group consisting of fluorinated vinyl propylene copolymer, polyfluoroethylene, polyether sulfone resin, polyphenylene sulfide, polybutylene terephthalate, polyethylene, acrylonitrile-butadiene-styrene copolymer, polymethyl methacrylate, polycarbonate, cyclic olefin polymer, nylon, polyformaldehyde, polyvinyl chloride, or polypropylene, preferably nylon, polyethylene, polypropylene, or cyclic olefin polymer.

10. A method for preparing microdroplets, comprising the following steps:

providing a sample adding needle;

filling the sample adding needle with a carrier oil and the carrier oil in the sample adding needle is free of air bubbles;

providing a first open container containing a sample solution, moving the sample adding needle so that the liquid discharge opening of the liquid discharge portion is located above the liquid level of the first open container;

moving the sample adding needle downward so that the liquid discharge opening contacts and is immersed in the sample solution, making the sample solution to be drawn into the sample adding needle;

providing a second open container containing an oily liquid, moving the sample adding needle with drawn sample solution above the liquid level of the second open container;

moving the sample adding needle downward so that the liquid discharge opening contacts and is immersed in the oily liquid, making the sample adding needle to perform periodic reciprocating motion within the oily liquid and discharging the liquid so that the sample solution within the liquid discharge opening enters the oily liquid to form uniformly sized microdroplets.

11. The method according to item 10, wherein the sample adding needle is the sample adding needle of any one of items 1-9.

12. The method for preparing microdroplets according to item 10, wherein the periodic reciprocating motion is a periodic reciprocating motion with a varying speed or acceleration.

13. The method for preparing microdroplets according to item 10, wherein the position waveform of the periodic reciprocating motion is a sine wave, a square wave, a triangle wave, a trapezoidal wave, a sawtooth wave or a superposition or combination of the above waveforms.

14. The method for preparing microdroplets according to item 10, wherein the carrier oil is not intermiscible with the sample solution; and the oily liquid is not intermiscible with the sample solution.

15. The method for preparing microdroplets according to item 10, wherein in the process of filling the sample adding needle with carrier oil and the sample adding needle discharging to produce droplets, whether there are bubbles in the sample adding needle is detected using the bubble detection method or determined by manual observation to exclude the effect of bubbles on the droplet volume uniformity.

The sample adding needle for preparing microdroplets according to the present application, by adopting a design in which “an upper part is provided with an adaptation portion for connecting a liquid supply adapter, a middle part is provided with a liquid storage portion for sample storage, and a lower part is provided with a liquid discharge portion for microdroplet production, the upper opening of the adaptation portion is the liquid supply opening, the lower opening of the liquid discharge portion is the liquid discharge opening, and from the liquid supply opening to the liquid discharge opening, the diameter decreases; the liquid discharge opening has an inner diameter of 25 to 200 microns and an outer diameter of 200 to 800 microns, and when the sample adding needle contacts the sample solution and the oily liquid, the contact angle is not less than 80°”, when preparing microdroplets through the sample adding needle, as the sample adding needle performs periodic reciprocating motion with a varying speed within the oily liquid, the sample solution is subjected to periodic shearing force of the oily liquid at the liquid discharge opening, which in turn makes the sample solution in the sample adding needle to enter the oily liquid, thus achieving production of microdroplets with uniform size and controllable volume.

As for the sample adding needle for preparing microdroplets of the present application, the taper of the liquid storage portion is C1, the taper of the liquid discharge portion is C2, and C1≤C2, the wall thickness of the liquid storage portion is D1, the wall thickness of the liquid discharge portion is D2, and D1>D2. The larger taper structure of the liquid discharge portion ensures the machinability of the tiny opening at the front end and the life of the mold, and also ensures the rigidity of the liquid discharge portion. The thicker wall thickness of the liquid storage portion ensures the overall rigidity of the sample adding needle, while the thinner liquid discharge portion ensures the smaller size of the front end of the needle, which helps to reduce the attenuation of the fluid shear force by the tube wall during reciprocating motion and the disturbance of the oil phase, promoting the reliable production of microdroplets.

### BRIEF DESCRIPTION OF THE DRAWINGS

The drawings are for the better understanding of this application and do not constitute an improper limitation to this application. Wherein:

FIG. 1 is a schematic view of the sample adding needle for preparing microdroplets as disclosed in the present application.

FIG. 2 is a bottom view of the sample adding needle for preparing microdroplets as disclosed in this application.

FIG. 3 is an enlarged view of part A of FIG. 2, showing a schematic view of the structure of the liquid discharge opening of the sample adding needle provided in the present application.

FIG. 4 shows a schematic view of the liquid storage portion and the liquid discharge portion of the present application.

FIG. 5 shows a schematic diagram of the operation steps for preparing microdroplets using the microdroplet preparation method disclosed in the present application.

FIGS. 6A, 6B and 6C are schematic diagrams of the principle of generating microdroplets that a vibration mechanism drives the sample adding needle to perform a periodic reciprocating motion under or across the liquid level at a varying speed in a specific embodiment of the present application.

FIG. 7 is a graph of experimental results of generating microdroplets in Test example 1.

FIGS. 8A-8D are schematic diagrams of the tube wall shape of the liquid discharge opening of this application.

### LIST OF REFERENCE SIGNS IN THE DRAWINGS

110—Sample adding needle; 120—Liquid discharge portion; 130—Liquid storage portion; 140—Adaptation portion; 150—Liquid discharge opening; 160—Liquid supply opening; 170—Liquid supply adapter; 180—Step portion; 190—Reinforcement rib; 200—Sample solution; 210—Oily liquid; 220—Microdroplet; 230—Carrier oil; 240—Vibration mechanism.

### DETAIL DESCRIPTION OF THE INVENTION

The exemplary embodiments of the present application are described below in conjunction with the drawings, which include various details of the embodiments of the present application to facilitate understanding, and should be considered merely exemplary. Accordingly, one of ordinary skill in the art should recognize that various changes and modifications can be made to the embodiments described herein without departing from the scope and spirit of the present application. Also, for clarity and brevity, descriptions of well-known features and structures have been omitted from the following description.

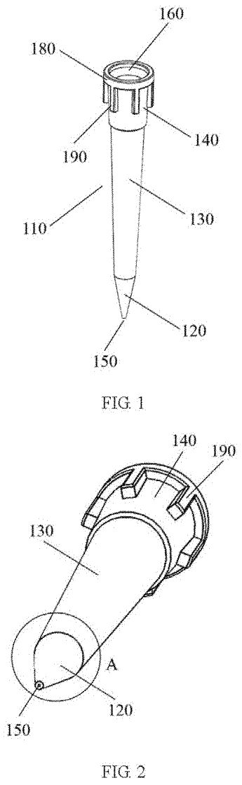

Referring to FIGS. 1-4, the present application provides a sample adding needle 110 for preparing microdroplets, comprising a liquid storage portion 130 and a liquid discharge portion 120 which are integrally molded and penetrate one another, the liquid storage portion 130 is a hollow truncated cone the radial dimension of which gradually decreases in the direction facing the liquid discharge portion 120, the liquid discharge portion 120 is a hollow truncated cone the radial dimension of which gradually decreases in the direction away from the liquid storage portion 130, the taper of the liquid storage portion 130 is C1, the taper of the liquid discharge portion 120 is C2, and C1≤C2, the wall thickness of the liquid storage portion is D1, the wall thickness of the liquid discharge portion is D2, and D1>D2. The structure of the larger taper of liquid discharge portion 120 ensures the machinability of the tiny opening at the front end and the life of the mold, and also ensures the rigidity of the liquid discharge portion 120. The thicker wall thickness of the liquid storage portion 130 ensures the overall rigidity of the sample adding needle, while the thinner wall of liquid discharge portion 120 ensures the smaller size of the front end of the sample adding needle, which facilitates the generation of microdroplets.

The taper is the ratio of the bottom diameter of the cone to the height of the cone, or in the case of a truncated cone, the ratio of the difference between the diameters of the upper and lower bottom circles to the height of the truncated cone.

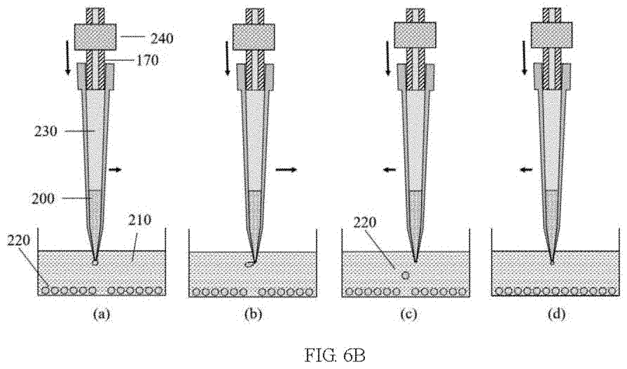

As shown in FIG. 4, (a) is a schematic diagram of the liquid storage portion and (b) is a schematic diagram of the liquid discharge portion.

The taper of the liquid storage portion 130

$$C 1 = \frac{R 1 - R 2}{H}$$

Taper of the liquid discharge portion 120

$$C 2 = \frac{r 1 - r 2}{h}$$

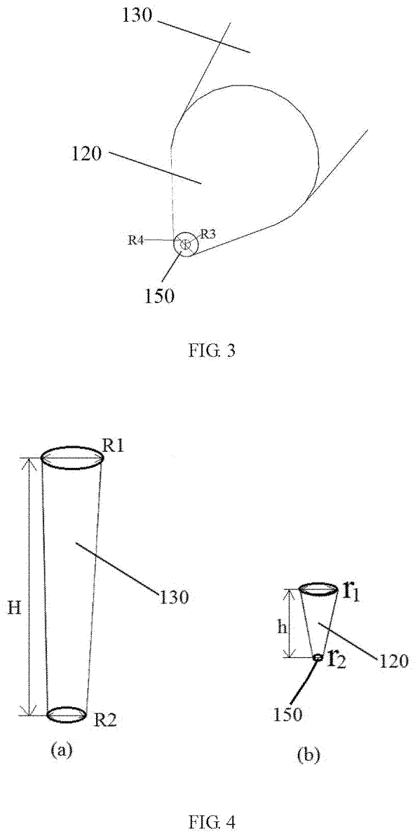

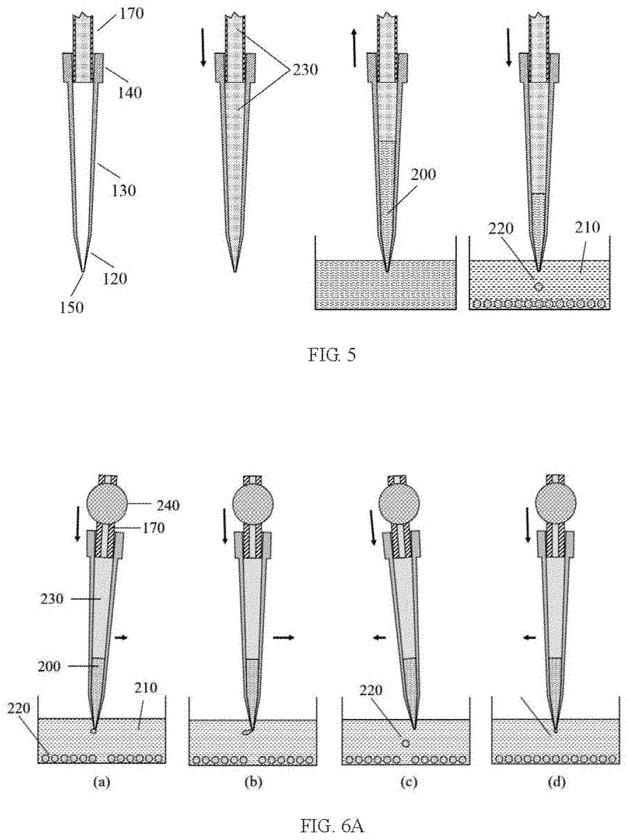

As shown in FIG. 2-FIG. 3, the liquid storage portion 130 and the liquid discharge portion 120 are both hollow truncated cone-like structures with openings at both ends, wherein the liquid storage portion 130 can be a hollow truncated cone-like structure with openings at both ends, the liquid discharge portion 120 can be a hollow truncated cone-like structure with openings at both ends, and the lower end of the liquid storage portion 130 is integrally molded with the upper end of the liquid discharge portion 120. The liquid storage portion 130 is used to store the carrier oil 230 and the liquid discharge portion 120 is used to draw the sample solution 200.

When the sample adding needle 110 is preparing microdroplets 220, fill the sample adding needle 110 with carrier oil 230 and the carrier oil 230 in the sample adding needle 110 is free of air bubbles; then place the sample adding needle 110 under the liquid level of the first open container containing the sample solution 200 so that the liquid discharge portion 120 of the sample adding needle 110 draws the sample solution 200; then move the liquid discharge portion 120 that has drawn the sample solution 200 to be under the liquid level of the second open container containing the oily liquid 210, so that the liquid discharge opening 150 contacts and is immersed in the oily liquid 210, then the needle 110 is moved in a periodic reciprocating motion with a varying speed in the oily liquid 210, so that the adsorption force of the sample solution 200 at the liquid discharge opening 150 is weakened, thereby causing the sample solution 200 in the sample adding needle 110 enter the oily liquid 210, thus achieving the production of microdroplet 220 with uniform size and controllable volume.

In an embodiment of the present application, the liquid storage portion 130 has a height of 3 to 50 mm, preferably 5 to 30 mm, a taper of 2 to 30°, preferably 2 to 20°, and a wall thickness of 0.3 to 2.0 mm, preferably 0.4 to 0.5 mm.

The height of the liquid storage portion 130 can be any one of 3 mm, 4 mm, 5 mm, 6 mm, 7 mm, 8mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, and 50 mm.

The taper of the liquid storage portion 130 can be any one of 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, and 30°.

The wall thickness of the liquid storage portion 130 can be 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, and 2.0 mm.

In an embodiment of the present application, the liquid discharge portion 120 has a height of 1 to 10 mm, preferably 2 to 5 mm, a taper of 10 to 60°, preferably 10 to 20°, and a wall thickness of 0.05 to 0.3 mm, preferably 0.1 to 0.2 mm.

The height of the liquid discharge portion 120 can be any one of 1 mm, 2 mm, 3 mm, 4 mm, 5 mm, 6 mm, 7 mm, 8 mm, 9 mm, and 10 mm.

The taper can be any one of 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, and 60°.

The wall thickness of the liquid discharge portion 120 can be 0.05 mm, 0.06 mm, 0.07 mm, 0.08 mm, 0.09 mm, 0.1 mm, 0.11 mm, 0.12 mm, 0.13 mm, 0.14 mm, 0.15 mm, 0.16 mm, 0.17 mm, 0.18 mm, 0.19 mm, 0.2 mm, 0.21 mm, 0.22 mm, 0.23 mm, 0.24 mm, 0.25 mm, 0.26 mm, 0.27 mm, 0.28 mm, 0.29 mm, and 0.3 mm.

The larger taper of the liquid discharge portion 120 enables a shorter height of the liquid discharge portion 120 while ensuring a smaller inner and outer diameter of the liquid discharge opening 150, increasing the mechanical strength of the liquid discharge portion 120 of the sample adding needle 110 and contributing to the stability of the microdroplet 220 preparation and the homogeneity of the microdroplet 220.

In an embodiment of the present application, the liquid storage portion 130 is provided with an adaptation portion 140 at the end away from the liquid discharge portion 120, the adaptation portion 140 is a truncated cone the radial dimension of which gradually decreases in the direction facing the liquid discharge portion 120, and the adaptation portion is integrally molded with the liquid storage portion.

The adaptation portion 140 can be used to connect to the liquid supply adapter 170, so that the carrier oil 230 enters the liquid storage portion 130 through the liquid supply adapter 170.

The adaptation portion 140 can be a hollow truncated cone structure with openings at both ends.

The liquid storage portion 130 is tightly connected to the adaptation portion 140.

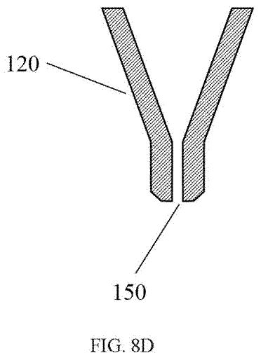

In an embodiment of the present application, as shown in FIG. 8A, the adaptation portion 140 has an liquid supply opening 160 at the end away from the liquid discharge portion 120, and the liquid discharge portion 120 has an liquid discharge opening 150 at the end away from the liquid storage portion 130.

Three variants of the liquid discharge openings are as shown in FIGS. 8B-8D, wherein the liquid discharge openings are set to have equal inner diameters and the liquid discharge openings have equal or gradually decreasing outer diameters along the axial direction. In FIG. 8B the liquid discharge opening 150 is hollow and cylindrical and both the inner and outer diameters of the liquid discharge opening are equal, the liquid discharge opening 150 is integrally molded with the liquid discharge portion 120, and the inner diameters of the ends of the liquid discharge portion 120 are equal to the inner diameters of the liquid discharge opening 150 and penetrate one another. FIGS. 8C and 8D differ from FIG. 8B in that the outer diameter of the lower portion of the liquid discharge opening 150 in FIGS. 8C and 8D decreases gradually along the axial direction.

The liquid supply opening 160 is plugged with the liquid supply adapter 170, thereby enabling the carrier oil 230 to enter smoothly into the liquid storage portion 130.

As shown in FIG. 3, the liquid discharge opening 150 has an inner diameter R3 of 25 to 200 μm, preferably 50 to 200 μm, more preferably 100 to 180 μm; the liquid discharge opening 150 has an outer diameter R4 of 200 to 800 μm, preferably 250 to 550 μm, more preferably 350 to 450 μm.

The inner diameter R3 of the liquid discharge opening 150 can be any one of 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm 130 μm, 135 μm, 140 μm, 145 μm, 150 μm, 155 μm, 160 μm, 165 μm, 170 μm, 175 μm, 180 μm, 185 μm, 190 μm, 195 μm, and 200 μm.

The outer diameter R4 of the liquid discharge opening 150 can be any one of 200 μm, 210 μm, 220 μm, 230 μm, 240 μm, 250 μm, 260 μm, 270 μm, 280 μm, 290 μm, 300 μm, 310 μm, 320 μm, 33 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, 500 μm, 510 μm, 520 μm, 530 μm, 540 μm, 550 μm, 560 μm, 570 μm, 580 μm, 590 μm, 600 μm. 610 μm, 610 μm, 620 μm, 630 μm, 640 μm, 650 μm, 660 μm, 670 μm, 680 μm, 690 μm, 700 μm, 710 μm, 720 μm, 730 μm, 740 μm, 750 μm, 760 μm, 770 μm, 780 μm, 790 μm, and 800 μm.

In an embodiment of the present application, the adaptation portion 140 is provided with a step 180 surrounding the adaptation portion 140 at the end away from the liquid discharge portion 120, and the step 180 is provided with at least one reinforcing rib 190 at the end facing the liquid discharge portion 120. i.e., the outer surface of the liquid supply opening 160 is provided with the step 180 surrounding the adaptation portion 140. The step 180 is circular in shape and the step 180 is integrally molded on the adaptation portion.

The step portion 180 is disposed at the liquid supply opening 160 of the adaptation portion 140, and the step portion 180 is tightly connected to the adaptation portion 140. The diameter of the step is greater than the diameter of the placement hole for the sample adding needle 110 in the sample adding needle 110 box, and part of the step contacts the bearing surface in the sample adding needle 110 box, making the sample adding needles 110 are placed in an array and suspended in the sample adding needle 110 box.

The number of the reinforcement ribs 190 can be 1, 2, 3, 4, 5, or more, and when the reinforcement ribs 190 are multiple, the multiple reinforcement ribs 190 can be set at equal intervals. The multiple reinforcement ribs 190 can increase the mechanical strength of the sample adding needle 110 when the liquid supply adapter 170 is tightly plugged with the adaptation portion 140.

In an embodiment of the present application, the reinforcement rib 190 and the adaptation portion 140 both extend towards the liquid discharge portion 120, i.e., the extension direction of the reinforcement rib 190 is the same as the extension direction of the adaptation portion 140, and the bottom of the reinforcement rib 190 is connected to the adaptation portion 140 (here the bottom of the reinforcement rib 190 is the side of the reinforcement rib 190 facing the adaptation portion 140).

In an embodiment of the present application, the adaptation portion 140 has a height of 3 to 8 mm, preferably 3 to 5 mm; a taper of 2 to 6°, preferably 3 to 4.5°.

The height of the adaptation portion 140 can be any one of 3 mm, 3.5 mm, 4 mm, 4.5 mm, 5 mm, 5.5 mm, 6 mm, 6.5 mm, 7 mm, 7.5 mm, and 8 mm.

The taper of the adapter 140 can be any one of 2°, 2.5°, 3°, 3.5°, 4°, 4.5°, 5°, 5.5°, and 6°.

The taper of the part through which the liquid supply adapter 170 is tightly plugged with the adaptation portion 140 is 2-6°, ensuring air tightness at the connection of the liquid supply adapter 170 to the sample adding needle 110.

In an embodiment of the present application, the liquid storage portion 130 has a reservoir volume of 5-500 μL, preferably 20-60 μL.

The liquid storage portion 130 has a reservoir volume of any one of 5 μL, 10 μL, 20 μL, 30 μL, 40 μL, 50 μL, 60 μL, 70 μL, 80 μL, 90 μL, 100 μL, 150 μL, 200 μL, 250 μL, 300 μL, 350 μL, 400 μL, 450 μL, and 500 μL.

When preparing microdroplets using the sample adding needle 110 and method for preparing microdroplets provided in this application, the volume of sample solution 200 drawn in the sample adding needle 110 is within the range of the reservoir volume of the sample adding needle 110, preventing excessive sample solution 200 from entering the supply adapter 170 and resulting in cross-contamination.

The sample adding needle 110 in this application is made of a material having a contact angle of not less than 80 degrees with pure aqueous solution, the material including but not limited to any one of fluorinated vinyl propylene copolymer (FEP), polyvinyl fluoride (PVF), polyethersulfone resin (PES), polyphenylene sulfide (PPS), polybutylene terephthalate (PBT), polyethylene (PE), acrylonitrile-butadiene-styrene copolymer (ABS), polymethyl methacrylate (PMMA), polycarbonate, cyclic olefin polymer, nylon, polyformaldehyde, polyvinyl chloride, or polypropylene, preferably any one of nylon, polyethylene, polypropylene, and cyclic olefin polymer.

Fluorinated vinyl propylene copolymer (FEP, contact angle of 98 degrees) is made by polymerization of tetrafluoroethylene and hexafluoropropylene, having excellent heat resistance, insulating property, corrosion resistance, weather resistance, low friction coefficient, and other characteristics. Polyvinyl fluoride (PVF, contact angle of 98 degrees) is a fluoroethylene homopolymer having excellent heat resistance, insulating property, corrosion resistance, radiation resistance, impact resistance, and other characteristics. Polyethersulfone resin (PES, contact angle of 90 degrees) is a thermoplastic polymer material of excellent comprehensive performance, having excellent heat resistance, physical and mechanical properties, insulation property, processability, etc., especially having outstanding features that it can be continuously used at high temperatures and still maintain a stable performance in the environment with rapid temperature changes. Polyphenylene sulfide (PPS, contact angle of 87 degrees) is a special engineering plastics with excellent comprehensive performance, having high temperature resistance, corrosion resistance, radiation resistance, flame retardant property, physical and mechanical properties, dimensional stability, electrical property and other characteristics. Polybutylene terephthalate (PBT, contact angle of 88 degrees) is a special engineering plastics with excellent comprehensive performance, having excellent heat resistance, toughness, fatigue resistance, resistance to organic solvents, self-lubrication, low coefficient of friction and other characteristics. Polyethylene (PE, contact angle of 88 degrees) is a thermoplastic resin with excellent low temperature resistance, chemical stability, corrosion resistance, electrical insulation and other characteristics. Acrylonitrile-butadiene-styrene copolymer (ABS, contact angle of 82 degrees) is a thermoplastic polymer material with high strength, good toughness and easy processing and molding, having corrosion resistance, impact resistance, high flame retardancy, high heat resistance, high transparency, and other characteristics. Polymethyl methacrylate (PMMA, contact angle of 82 degrees) has excellent transparency, processability, mechanical strength, insulating property, weather resistance, heat resistance and other characteristics. Polypropylene (PP, with a contact angle of 88 degrees) is a thermoplastic synthetic resin with excellent properties, having chemical resistance, heat resistance, electrical insulation, high strength mechanical properties and processability of good and high abrasive resistance and other characteristics.

In this application, the end where the adaptation portion 140 is located is the upper side/upper part, and the end where the liquid discharge portion 120 is located is the lower side/lower part.

In one specific embodiment, the sample adding needle is prepared by an injection molding process, using a prepared metal injection mold cavity to produce a sample adding needle of said shape from molten raw materials such as polypropylene pre-added with hydrophobic accessories and other raw materials through pressurization, injection, pressure-holding, cooling, de-filming and other operations. The injection molding process described above allows for the production of the above-mentioned sample adding needle in large quantities at low cost.

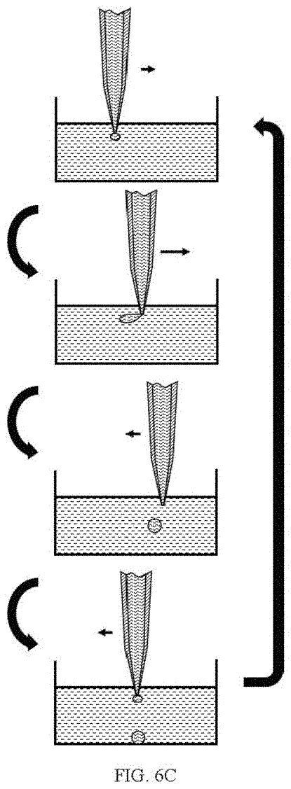

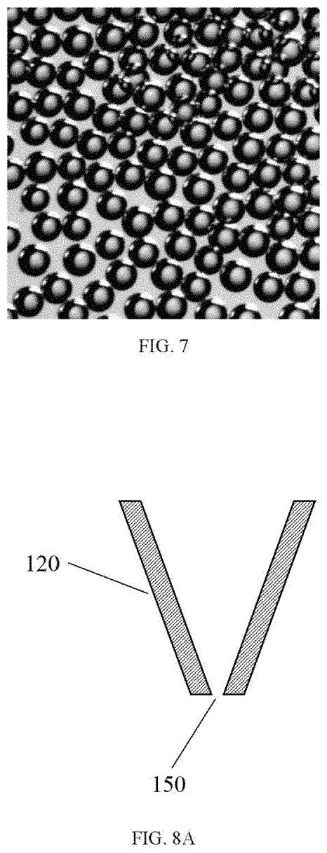

As shown in FIG. 5, FIG. 6A, 6B, and FIG. 6C, the present application also provides a method for preparing microdroplets, comprising the following steps:

A: providing the sample adding needle 110, the sample adding needle adapter 170, and a precision syringe pump connected to the sample adding needle adapter 170 via a pipe.

B: mounting the sample adding needle 110 tightly on the sample adding needle adapter 170; filling the sample adding needle 110 with carrier oil 230 through the sample adding needle adapter 170, and the carrier oil 230 in the sample adding needle 110 is free of air bubbles.

C: providing a first open container containing a sample solution 200, moving the sample adding needle 110 so that the liquid discharge opening 150 of the liquid discharge portion 120 is located above the liquid level of the first open container.

D: moving the sample adding needle 110 downward so that the liquid discharge opening 150 contacts and is immersed in the sample solution 200, so that the sample solution 200 is drawn into the sample adding needle 110.

E: providing a second open container containing an oily liquid 210, moving the sample adding needle 110 with the drawn sample solution 200 above the liquid level of the second open container.

F: moving the sample adding needle 110 downward so that the liquid discharge opening 150 contacts and is immersed in the oily liquid 210, moving the sample adding needle 110 in a periodic reciprocating motion within the oily liquid 210 so that the sample solution 200 in the liquid discharge opening 150 enters the oily liquid 210, forming microdroplets 220 with uniform size. The volume of a microdroplet 220 can be 50 pL-50 nL; when the inner diameter of the liquid discharge opening 150 is 45 μm, the minimum volume of the droplet 220 can be 50 pL; when the inner diameter of the liquid discharge opening 150 is 78 μm, the minimum volume of the droplet 220 can be 250 pL; when the inner diameter of the liquid discharge opening 150 is 200, the minimum volume of the droplet 220 can be 50 nL.

As shown in FIG. 6A, in step F the vibration mechanism is connected to the sample adding needle 110, and the sample adding needle 110 is driven by the vibration mechanism 240 to perform a periodic reciprocating motion with a varying speed within the oily liquid 210. When vibrating, the adapter carries the sample adding needle, driven by the oscillating device, to oscillate at high speed around the axis, with an oscillation frequency preferably between 100 Hz and 500 Hz, the liquid discharge opening of the sample adding needle being 4 to 6 cm from the axis, and the amplitude of the reciprocating motion of the liquid discharge opening preferably being in the range of 0.1 to 5 mm, more preferably in the range of 0.5 to 2 mm.

As shown in FIG. 6B, in step F the vibration mechanism is connected to the sample adding needle 110, and the sample adding needle 110 is driven by the horizontal vibration mechanism 240 to perform a periodic reciprocating motion with a varying speed within the oily liquid 210. When vibrating, the adapter carries the sample adding needle, driven by the vibration mechanism, to perform a horizontal reciprocating motion with an oscillation frequency preferably between 100 Hz and 500 Hz, more preferably between 100 Hz and 150 Hz, and a vibration distance of 0.1 to 5 mm, more preferably 0.5 to 2 mm, for the reciprocating motion of the liquid discharge opening.

The velocity profile of the liquid discharge opening 150 of the sample adding needle 110 can be in the form of a sine wave, square wave, triangle wave, trapezoidal wave, sawtooth wave or a superposition and combination of the above waveforms.

The sample adding needle 110 performs a periodic reciprocating motion with a varying speed. In one reciprocating motion cycle, it produces 0.5 or 1 microdroplet 220, preferably 1 microdroplet 220. As shown in FIG. 6C, in step F, the vibration mechanism 240 drives the sample adding needle 110 to perform a periodic variable motion. First, the sample adding needle 110 performs a accelerated motion from left to right; then, the sample adding needle 110 reaches the maximum speed in one vibration cycle when it's moving from left to right, so that the shearing force of the oil relative to the liquid injected by the liquid discharge opening of the sample adding needle achieves the cutting of the droplet on the outside of the opening; then, the sample adding needle performs a decelerated motion until reaching the farthest position on the right; finally, the sample adding needle moves at a low speed back to the left to complete one vibration cycle. The above-mentioned variable speed motion can achieve the cutting of one droplet in one vibration cycle. The position-time wave form of the reciprocating motion of the liquid discharge opening of the sample adding needle 110 is an asymmetric waveform in one vibration cycle. The above vibration form produces 1 droplet in a vibration cycle only when moving from left to right, instead of producing 1 droplet in each of the two half-cycles from left to right and from right to left, i.e., producing two droplets in one reciprocating motion cycle. This waveform and droplet producing mechanism has a very good tolerance for the non-axis of the inner and outer holes during injection mold clamping, and also effectively avoids the inconsistent volume of droplets produced from both the left and the right due to the processing accuracy and minor defects of the liquid discharge opening.

The the vibration mechanism 240 drives the sample adding needle 110 to perform a periodic reciprocating motion with a varying speed under the liquid level, and the flow rate of the sample solution 200 is all positively correlated with the diameter of the produced droplets 220, and the diameter of the produced droplets 220 becomes larger when increasing the flow rate of the sample solution 200 in the sample adding needle 110. The vibration frequency of the sample adding needle 110 is all negatively correlated with the diameter of the produced droplets 220, and the diameter of the produced droplets 220 becomes smaller as the vibration frequency of the sample adding needle 110 increases. Therefore, the diameter of the microdroplet 220 produced with the sample adding needle 110 and the method for preparing microdroplets disclosed in this application can be controlled by the flow rate of the sample solution 200 in the sample adding needle 110 and the vibration frequency of the sample adding needle 110, and the volume control of the microdroplet 220 can be adjusted relatively flexibly. In addition, the cross-contamination of different batches of samples can be avoided by the plug-in and plug-out quick change of the sample adding needle 110; at the same time, the components of the flowing solution in the sample adding needle 110 can be changed to form multiple microdroplets 220 with different components and volumes in the open container in sequence, which can be used to realize both high-throughput screening of microdroplets 220 and multi-step ultra-micro biochemical reactions and assays, having wide application prospects.

Using the sample adding needle and method for preparing microdroplets described in this application, during the process of filling the sample adding needle with carrier oil and the sample adding needle discharging to produce droplets, whether there are bubbles in the sample adding needle is detected by bubble detection methods or determined by manual observation to exclude the effect of bubbles on the droplet volume uniformity. For example, a white LED is used to illuminate the sample adding needle from the side at the position horizontal to the sample adding needle, and a high-resolution video acquisition CCD camera is used to image the sample adding needle from the front at the direction vertical to the illumination LED, and a deep learning algorithm is used to analyze the acquired images in real time to determine whether air bubbles exist in the sample adding needle. In the presence of air bubbles, the user is prompted to replace the sample adding needle and conduct the experiment again, or through an automated mechanism, to achieve automatic replacement of the sample adding needle to ensure size uniformity of the produced droplets and to avoid experimental failure and sample waste due to the presence of air bubbles.

The shape of the first opening container as well as the second opening container in the present application is not limited, belonging to the prior art, as long as it can achieve the function in the present application.

In an embodiment of the present application, the carrier oil 230 is immiscible with the sample solution 200; the oily liquid 210 is immiscible with the sample solution 200.

In this application the carrier oil 230 can be one or more of mineral oil, silicone oil, liquid alkane, or liquid ester; oily liquid 210 is one or more of mineral oil, silicone oil, liquid alkane, or liquid ester, containing a suitable amount of ionic surfactant or nonionic surfactant, such as Tween series surfactant, Span series surfactant, silicone chain nonionic surfactant containing long chain alkyl; sample solution 200 is pure aqueous solution, PEG or DMSO, and it can also be a mixture, such as PCR reagent, cell culture solution, biological sample, buffer solution, etc.

### EXAMPLE

### Example 1

The reservoir volume of the sample adding needle 110 described in this application is 60 microliters, the material used to prepare the sample adding needle 110 is polypropylene (PP, contact angle of 88 degrees with the pure aqueous solution). For the liquid discharge portion 120, the height is 5 mm, the taper is 20°, and the wall thickness is 0.15 mm. For the liquid storage portion 130, the height is 18.7 mm, the taper is 4°, and the wall thickness is 0.5 mm. For the adaptation portion, the height is 6 mm, and the taper is 4°. And for the liquid discharge opening 150, the inner diameter is 100 μm and the outer diameter is 400 μm. The cavity and inner core of the precision metal injection mold were made according to the above dimensions, and the injection molding process was used to process a large number of automatic sample adding needles. The processing yield is 99.98% (batch inspection quantity of 10000 pcs).

### Test Example 1

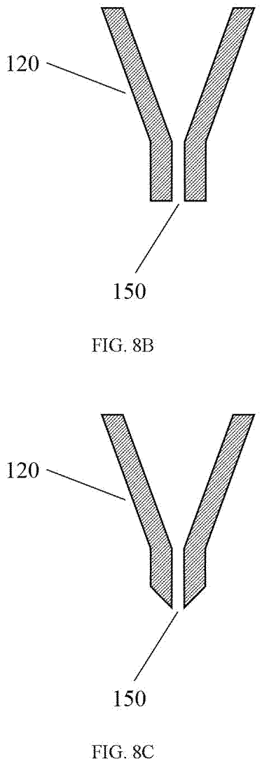

The sample adding needle 110 as described in Example 1 is used. The upper opening of the adaptation portion 140 of the sample adding needle 110 is tightly plugged with one end of the liquid supply adapter 170, and the other end of the liquid supply adapter 170 is connected to a precision syringe pump which has a three-way valve through a Teflon hose. The syringe pump is equipped with a microsampler with a volume of 50 μL and the sample adding needle 110 is fixed to a vibration mechanism. The liquid supply adapter 170 can be directly plugged with and matches the upper opening of the needle 110 adapter 140, allowing easy removal and replacement of the needle 110. Before microdroplet production, the Teflon hose, the liquid supply adapter 170 and the sample adding needle 110 are filled with mineral oil, and the liquid path is checked for leak-free and bubble-free. With the suction of the microsampler, 25 μL of 1 mg/mL BSA solution (buffer system of 1×PBS, pH=7.5) is drawn into the sample adding needle 110 at a rate of 2.5 μL/s from the first open container containing the sample solution 200, and the sample adding needle 110 is moved over the second open container containing mineral oil comprising 3% wt ABIL EM90. A waveform generator is used as a driving signal generator for the variable speed periodic reciprocating motion of the sample adding needle 110 under or across the mineral oil surface, making the sample solution 200 discharged from the liquid discharge opening 150 to move relative to the oily liquid 210. Microdroplets 220 prepared at an amplitude of 1.2 mm, a frequency of 100 Hz, a microsampler flow rate of 100 nanoliters/second, and an injection volume of 20 microliters are shown in FIG. 7. When the microsampler is pressurized by the syringe pump, the sample solution 200 enters the oily liquid 210 at a constant rate, and the flow shear stress (periodic reciprocating motion under the level), interfacial tension and interfacial forces (periodic reciprocating motion across the level) due to the relative motion of the sample solution 200 and the oily liquid 210 cause the sample solution 200 discharging from the liquid discharge opening 150 of the sample adding needle 110 to break away from the liquid discharge opening 150 to form microdroplets 220 with a volume of nanoliter volume, and the CV of the radius of microdroplets 220 is less than 3%. In about 3.3 minutes, about 20,000 microdroplets 220 of 1 nanoliter volume are formed in the second open container.

The above suction and droplet production operation was repeated 50 times and the volume and uniformity of the droplets produced each time were examined separately. It was found that the sample adding needle can be used repeatedly and stably for a long time, and the produced droplets were all 1 nL with a CV less than 3%. The good hydrophobicity and lipophilicity of the sample adding needle surface ensure the ability of the needle to work stably for a long time.

### Comparative Example 1

Referring to the published patent (Chinese patent application number 201410655309.4) to process a sample adding needle with a metal capillary tube. The adaptable part, the liquid storage portion are of the same size as that in Example 1. The difference is that the liquid discharge portion in Comparative Example 1 is a stainless steel capillary tube, wherein the length of the stainless steel capillary tube is 1 cm, the inner diameter is 100 μm, the outer diameter is 240 μm, the capillary tube and the lower conical inner lumen of the liquid storage portion are connected. Using the injection molding method for processing, and then using dispensing to connect the capillary tube and injection molded parts. Due to the extremely small inner diameter of the capillary tube, the dispensing connection is prone to clogging. Due to the increased capillary tube cutting and processing, capillary tube surface polishing, surface treatment, and dispensing processes, the yield is about 33.6% (the number of 10,000 units) under the improved process conditions.

Using the procedure and parameters of Test Example 1, a structurally sound sample adding needle with metal capillary tube was picked and 25 μL of 1 mg/mL BSA solution (buffer system 1×PBS, pH=7.5) was drawn at a rate of 2.5 μL/s with the sample adding needle, which generated air bubbles in the liquid storage portion due to excessive resistance of the capillary tube, resulting in relatively large and unevenly produced droplets with an average volume of about 2.6 nanoliter, with a CV>25%.

### Test Example 2

Using a metal capillary sample adding needle as described in Comparative Example 1, and adopting the operation procedure in Test Example 1, the drawing rate was adjusted downward to 0.5 μL/s, and 25 μL of 1 mg/mL BSA solution (buffer system 1×PBS, pH=7.5) was drawn. It was found that no bubbles were generated in the liquid storage portion, however, the elapsed time was increased from 10 s to 50 s. Microdroplets were produced by shaking using the operation procedure in test example 1. Microscopic observation showed that, when about the first 2000 droplets were producing, the outer wall of the capillary tube remained hydrophobic, and the size of the produced droplets was 1 nL, with uniform size; thereafter, as the surface of the capillary tube was adsorbed by BSA and became hydrophilic, it was observed that solution adsorption occurred on the outer side of the outlet end face of the capillary tube, and the contact area between the injected liquid and the capillary tube became larger, and the volume of the produced droplets became 3 nL or 4 nL under the same vibration conditions, with a CV>30%, and uniform 1 nL droplet could not be generated.

TABLE 1
is the parameters of each examples of the
sample adding needle of this application

| | Ability for | | |
|---|---|---|---|
| | continuous | | |
| | production of | Processing | |
| | 1 nL droplets | cost | Yield |
| Test Example 1 | >100,000 | Low | 99.98% |
| Comparative | ~2,100 | High | 35% |
| Example 1 | | | |

It can be seen from the above examples and comparative example that the sample adding needle described in the present application has a high yield, low processing cost, and can continuously produce a large number of uniform microdroplets with a volume as low as 1 nanoliter.

Although the embodiments of the present application are described above in conjunction with the drawings, the present application is not limited to the specific embodiments and fields of application described above, and the specific embodiments described above are merely schematic and instructive, and not limiting. A person of ordinary skill in the art, under the inspiration of this specification and without departing from the scope protected by the claims of this application, can also make many kinds of forms, all of which fall within the protection of this application.

1. A sample adding needle for preparing microdroplets, comprising a liquid storage portion and a liquid discharge portion, which are integrally molded and penetrate one another, the liquid storage portion is a hollow truncated cone the radial dimension of which gradually decreases in the direction facing the liquid discharge portion, the liquid discharge portion is a hollow truncated cone the radial dimension of which gradually decreases in the direction away from the liquid storage portion, the taper of the liquid storage portion is C1, the taper of the liquid discharge portion is C2, and C1≤C2, the wall thickness of the liquid storage portion is D1, the wall thickness of the liquid discharge portion is D2, and D1>D2.

2. The sample adding needle for preparing microdroplets according to claim 1, wherein the liquid storage portion has a height of 3 to 50 mm, preferably 5 to 30 mm, a taper of 2 to 30°, preferably 2 to 20°, and a wall thickness of 0.3 to 2.0 mm, preferably 0.4 to 0.5 mm.

3. The sample adding needle for preparing microdroplets according to claim 1, wherein the liquid discharge portion has a height of 1 to 10 mm, preferably 2 to 5 mm, a taper of 10 to 60°, preferably 10 to 20°, and a wall thickness of 0.05 to 0.3 mm, preferably 0.1 to 0.2 mm.

4. The sample adding needle for preparing microdroplets according to claim 1, wherein the liquid storage portion is provided with an adaptation portion at the end away from the liquid discharge portion, the adaptation portion is a truncated cone the radial dimension of which gradually decreases in the direction facing the liquid discharge portion, and the adaptation portion and the liquid storage portion are integrally molded.

5. The sample adding needle for preparing microdroplets according to claim 4, wherein the adaptation portion is provided with a step portion surrounding the adaptation portion at the end away from the liquid discharge portion, the step portion is provided with at least one reinforcing rib at the end facing the liquid discharge portion, and the step portion is integrally molded on the adaptation portion.

6. The sample adding needle for preparing microdroplets according to claim 4, wherein the adaptation portion has a height of 3 to 8 mm, preferably 3 to 5 mm, and a taper of 2 to 6°, preferably 3 to 4.5°.

7. The sample adding needle for preparing microdroplets according to claim 4, wherein the adaptation portion has an liquid supply opening at the end away from the liquid discharge portion, and the liquid discharge portion has an liquid discharge opening at the end away from the liquid storage portion.

8. The sample adding needle for preparing microdroplets according to claim 7, wherein the liquid discharge opening has an inner diameter of 25 to 200 μm, preferably 50 to 200 μm, more preferably 100 to 180 μm; the liquid discharge opening has an outer diameter of 200 to 800 μm, preferably 250 to 550 μm, more preferably 350 to 450 μm.

9. The sample adding needle for preparing microdroplets according to claim 1, wherein the sample adding needle is made of a material having a contact angle of not less than 80 degrees with the pure aqueous solution, the material is one selected from the group consisting of fluorinated vinyl propylene copolymer, polyfluoroethylene, polyether sulfone resin, polyphenylene sulfide, polybutylene terephthalate, polyethylene, acrylonitrile-butadiene-styrene copolymer, polymethyl methacrylate, polycarbonate, cyclic olefin polymer, nylon, polyformaldehyde, polyvinyl chloride, or polypropylene, preferably nylon, polyethylene, polypropylene, or cyclic olefin polymer.

10. A method for preparing microdroplets, comprising the following steps:
providing a sample adding needle;
filling the sample adding needle with a carrier oil and the carrier oil in the sample adding needle is free of air bubbles;
providing a first open container containing a sample solution, moving the sample adding needle so that the liquid discharge opening of the liquid discharge portion is located above the liquid level of the first open container;
moving the sample adding needle downward so that the liquid discharge opening contacts and is immersed in the sample solution, making the sample solution to be drawn into the sample adding needle;
providing a second open container containing an oily liquid, moving the sample adding needle with drawn sample solution above the liquid level of the second open container;
moving the sample adding needle downward so that the liquid discharge opening contacts and is immersed in the oily liquid, making the sample adding needle to perform periodic reciprocating motion within the oily liquid and discharging the liquid so that the sample solution within the liquid discharge opening enters the oily liquid to form uniformly sized microdroplets.

11. The method according to claim 10, wherein the sample adding needle is the sample adding needle of claim 1.

12. The method for preparing microdroplets according to claim 10, wherein the periodic reciprocating motion is a periodic reciprocating motion with a varying speed or acceleration.

13. The method for preparing microdroplets according to claim 10, wherein the position waveform of the periodic reciprocating motion is a sine wave, a square wave, a triangle wave, a trapezoidal wave, a sawtooth wave or a superposition or combination of the above waveforms.

14. The method for preparing microdroplets according to claim 10, wherein the carrier oil is not intermiscible with the sample solution; and the oily liquid is not intermiscible with the sample solution.

15. The method for preparing microdroplets according to claim 10, wherein in the process of filling the sample adding needle with carrier oil and the sample adding needle discharging to produce droplets, whether there are bubbles in the sample adding needle is detected using the bubble detection method or determined by manual observation to exclude the effect of bubbles on the droplet volume uniformity.
